(19) United States
(12) Patent Application Publication
(10) Pub. No.: US 2015/0191939 A1
(43) Pub. Date: Jul. 9, 2015

(54) Secure Storage Device

(71) Applicant: Telezygology, Inc., Chicago, IL (US)

(72) Inventors: Dickory Rudduck, San Fransisco, CA (US); John Ker Wilson, Sydney (AU)

(73) Assignee: TELEZYGOLOGY, INC., Chicago, IL (US)

(21) Appl. No.: 14/412,856

(22) PCT Filed: Jul. 4, 2013
(86) PCT No.: PCT/IB13/55465

§ 371 Date: Jan. 5, 2015

(30) Foreign Application Priority Data
Jul. 4, 2012 (AU) 2012902855

(51) Int. Cl. E05B 65/52; G07C 9/00

(52) U.S. Cl. CPC E05B 65/52; G07C 9/00182

(57) ABSTRACT

This invention provides a secure storage device for a container (20a), the device including rail (60) and fastening means (68) adapted to attach the container (20a) to the rail (60). The fastening means (68) includes a first locking means adapted to release the container (20a) upon receipt of a signal.

### FIELD OF THE INVENTION

This invention relates to a secure storage device which is suitable for use in connection with a depot, such as a purpose built depot for holding items for collection, or for use in connection with a facility already available for other uses, such as a supermarket, convenience store or a gas station. In particular, the invention relates to a secure storage device for storing items securely at a collection point until collected, and which does not require a large capital investment.

### BACKGROUND OF THE INVENTION

The effective and secure delivery of items faces many difficulties.

Effecting delivery and maintaining security of delivery can be a problem in societies where the intended recipient is often not available to accept delivery. To effect delivery, a deliverer may have to make more than one attempt in order to hand over the item to the intended recipient. Each attempt at delivery after the first can erode or eliminate the profit obtained from the delivery. Security of delivery can be compromised if an item is left, unsecured, outside a recipient's door or in an unsecured letterbox.

The widespread practice of purchasing items through the internet means that the number of non-document items to be delivered is constantly increasing. The problem of effective and secure delivery of these items is becoming more urgent.

There have been attempts to address the problem of effecting delivery while at the same time securing the item to be delivered. These attempts have generally focused on installing locker systems in dedicated locations, so that a recipient can collect the item from a secure locker. An example is described in U.S. Pat. No. 6,791,450 (Gokcebay, assigned to Security People, Inc) which is directed to a system of locker compartments controlled by a central system processor. A drawback with this type of system is the high cost of the locker compartments. The lockers can also be bulky and require a significant amount of space.

It is an object of the present invention to provide a secure storage device which can enable secure and effective delivery of an item to a recipient.

It is also an object of the present invention to provide a secure storage device which may be provided with less expense than locker systems.

It is a further object of the invention to provide a secure storage device which is capable of occupying less space than a locker system.

### SUMMARY OF THE INVENTION

Accordingly, the present invention provides, in a first aspect, a secure storage device for a container. The device includes a rail and fastening means adapted to attach the container to the rail. The fastening means includes a first locking means wherein the first locking means is adapted to release the container upon receipt of a signal.

The present invention, in a second aspect, provides a container for securely storing an item.

The container includes a compartment for receiving the item. The compartment is closed by a closure, such as a sliding clasp fastener. A second locking means locks the closure. In one embodiment the container is capable of being locked to a secure storage device by a second locking means, adapted to be unlocked upon receipt of a signal.

The container of the second aspect of the invention may be of any suitable design or construction. Preferably, the container takes the form of a satchel, bag, envelope or box. The container of the invention may be provided in a range of sizes, to accommodate items of different size. The container may be insulated, so that it can keep hot items, like cooked food, hot and cold items, requiring refrigeration or being sensitive to heat, cold.

The second locking means may be a loop attachment attached to the container. The loop attachment may include a first part and a second part with the parts being releasably connected. Preferably, the first and second parts form a skirt adapted to cover a portion of the closure. The loop attachment may form a handle for the container.

In a third aspect, the invention provides a delivery system which includes the secure storage device described above and means to send the signal to the first locking means.

In a preferred embodiment the delivery system may include the container described above.

In a fourth aspect, the invention provides a method of securely delivering an item. The method includes providing the secure storage device described above, placing the item in a container, and locking the container to the secure storage device with the first locking means. The method provides a recipient with means to generate the signal for releasing the container.

The method may further include the step of scanning a barcode on the item to electronically store delivery advice.

The invention is particularly suitable for use in a convenience store, supermarket or gas station, although the scope of the invention is not limited to these. However, the invention below will be described, in a non-limiting way, in the context of a convenience store/gas station combination. Such a site has an advantage since it may be open for business during an extended period or even over 24 hours each day and can offer unlimited access to a recipient who may wish to collect a delivery after hours.

The rail is preferably of a suitable length in accordance with the installation site and preferably has associated with it a plurality of fasteners. The rail may be one of an array of rails. Different rails in the array may have different numbers of fasteners, which may be located at different spaced intervals along the rail. In this way, one rail may be designed to accommodate a number of slim containers or items with securing means, while another may accommodate a fewer number of bulkier containers or items. Alternately, each rail may be designed to accommodate a mix of slim and bulky containers or items.

At least one fastener is associated with each rail. Preferably, there is one fastener for each container or items with securing means, but in some applications more than one fastener may be preferred.

Each fastener may be incorporated in the rail or associated with it in some other way, such as in an extension which is fixed to the rail, either in a single position on the rail or in a sliding relationship with the rail.

The fastener is adapted to release the container upon receipt of a suitable signal. The fastener may be any suitable fastener, but is preferably a fastener from Telezygology Inc. Examples are disclosed in the following International Patent Applications, the contents of which are incorporated herein by reference: WO/1999/047819, WO/2004/001235, WO/2005/047714, WO/2006/105585, WO/2007/019641 and WO/2007/068035.

These are merely examples of a wide range of fasteners which may be used in the aspects of the present invention.

It is preferred that the fastener may be locked passively, without the need for a locking signal, but that the signal is required to release the fastener.

The signal for release or unlocking may be derived from a wide variety of sources. It may be sent wirelessly or through wiring. Wireless transmission can occur through any acceptable means.

The signal may result from the input of a code, generated by the merchant or another and communicated to the recipient for this purpose. It may result from recognition of a chip which the recipient has in a credit card used for the purchase of the item to be delivered. It may be a signal generated by the recipient's mobile phone. It may involve interrogation of an RFID tag or SAW chip. The invention is not restricted to these examples.

Any suitable signal and signal transmission means may be used.

The container may take any desirable form. In a simple embodiment, the container is a combination of the item or packaging in which the item is delivered, together with an adhesive handle or other means which can secure the item to the rail.

The container may be a plastic bag, with a handle which can which can secure the item to the rail.

Other suitable containers are within the scope of the invention.

The container of the invention is preferably made of strong but pliable material and is reasonably resistant to unauthorized opening—it cannot readily be torn, ripped or slashed, for example, to access an item in the compartment. In most circumstances, when the delivery system of the invention is installed in a convenience store/gas station, there will be monitoring of the location, by personnel and/or by closed circuit TV, so the security of the container need not be as robust as might otherwise be the case.

The container of the invention is preferably intended to be reused and retained in the convenience store/gas station, but it can be made available for hire or purchase by the recipient.

The container of the invention may include a security tag, such as a SAW chip or RFID tag, to ensure that it is not removed from the delivery locality without authorisation.

The compartment may take any suitable configuration. The compartment may for example be all or part of the inside of a satchel, bag, envelope or box.

The container, whether made in accordance with the second aspect of the invention or not, includes something (second locking means) which can be locked onto the rail. The second locking means may take any convenient form to enable this. A simple form is a loop or handle. Such a handle is described in connection with the drawings below, and may have a secondary function as handle for the container.

It is preferred that the deliverer advises the recipient that the delivery has been made. Such advice may be by SMS or email, for example. Preferably, the deliverer also transmits to the recipient the code which the recipient will use to input to generate the signal to release the item from the rail.

Other advantages and aspects of the present invention will become apparent upon reading the following description of the drawings and the detailed description of a preferred embodiment of the invention.

### BRIEF DESCRIPTION OF THE DRAWINGS

FIG. 1 shows a recipient ordering an item to be delivered using an embodiment of the delivery system and method of the invention;

FIG. 2 shows a deliverer in the process of making a delivery;

FIG. 3 shows the deliverer entering the convenience store in which the delivery system of the invention is located;

FIG. 4 shows the deliverer scanning an ID code on a container according to the invention;

FIG. 5 shows recipient receiving confirmation of delivery;

FIG. 6 shows the recipient's mobile phone display with an email from the deliverer in the display;

FIG. 7 shows the recipient's mobile phone display after the recipient has opened the email or an attachment to the email, revealing a QR code;

FIG. 8 shows a perspective view of an embodiment of delivery system of the invention installed in the convenience store shown in FIG. 3;

FIG. 9 shows in more detail part of the delivery system if FIG. 8 and shows two screen displays from an input device;

FIG. 10 is a perspective view of an embodiment of container of the invention, open to accept an item to be delivered;

FIG. 11 shows the container in FIG. 10 with the closure closing the compartment in which the item has been inserted; and

FIG. 12 shows the same container device with the closure locked under a combined first and second locking means.

### DETAILED DESCRIPTION OF THE PREFERRED EMBODIMENT

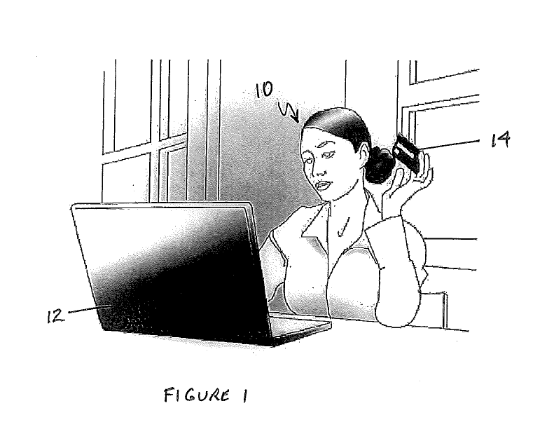

Referring first to FIG. 1, recipient 10 is shown in the process of ordering an item over the Internet, using computer 12 and credit card 14.

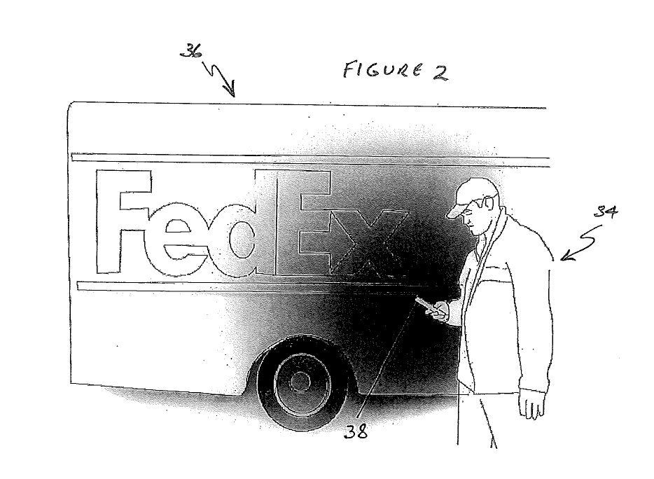

FIG. 2 shows a deliverer 34 outside delivery vehicle 36. Deliverer 34 is advising of delivery to recipient 10, using a mobile phone 38 or other electronic device capable of sending message to recipient 10.

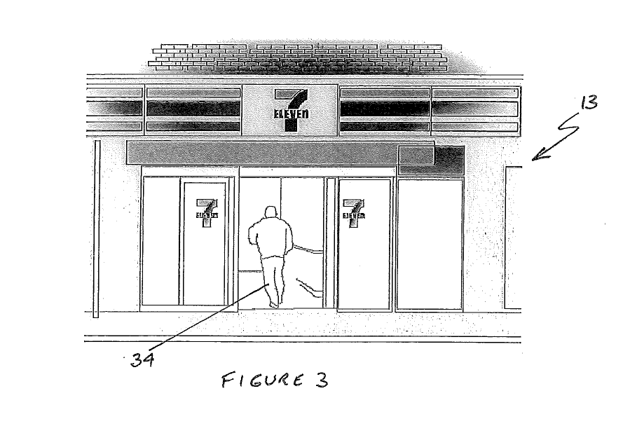

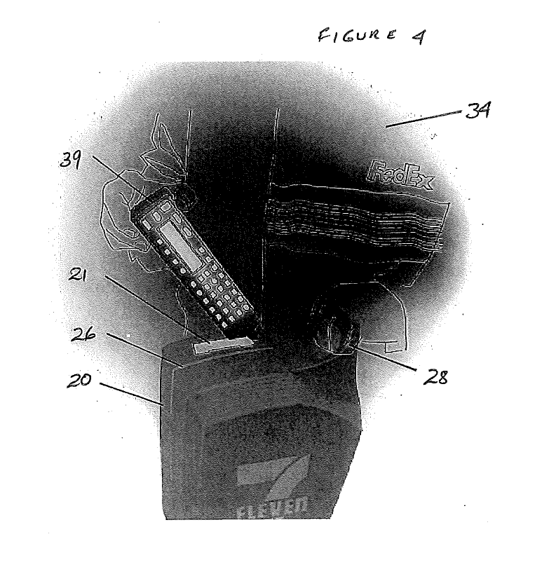

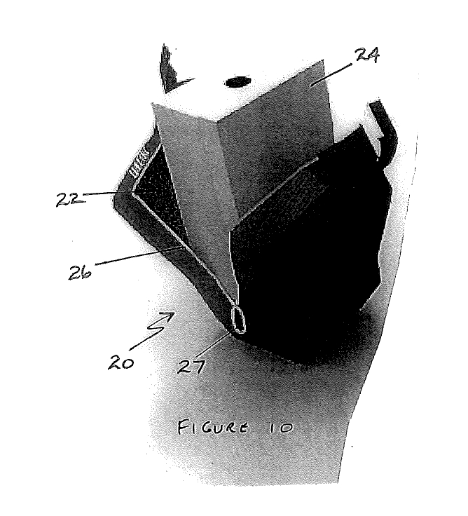

In FIG. 3, deliverer 34 is taking the item 24 (see FIG. 10) to be delivered into convenience store 13. As shown in FIG. 4, deliverer 34 has inserted item 24 into container 20, has closed closure 26, has assembled handle (second locking means) 28 and is scanning ID barcode (or similar) 21 on container 20. Scanning of barcode 21 can be used in a number of ways—to record electronically that deliverer 34 has completed the delivery for item 24, to generate the delivery advice to recipient 10 if not all ready done as described for FIG. 2, and to identify the precise container 20 in which item 24 has been inserted. Thus a log may be generated to track delivery.

Scanning can be effected by device 39 or by using device 38.

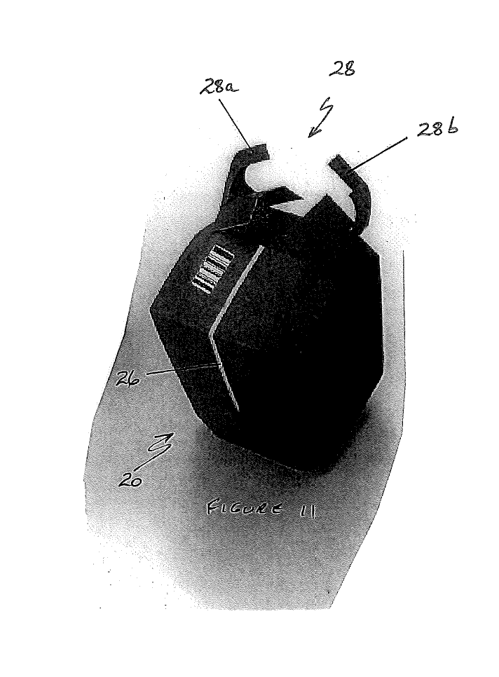

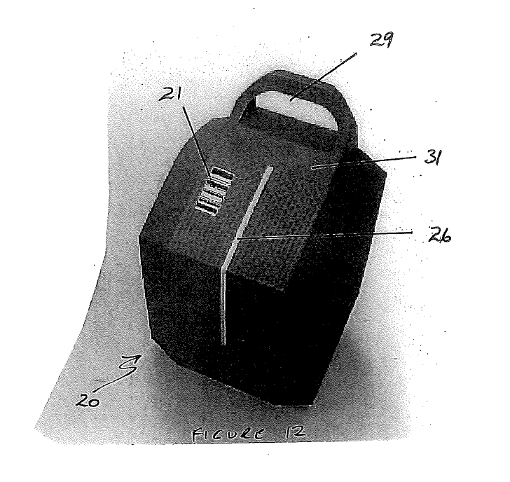

More details of the handle 28 are described in connection with FIGS. 11 and 12, below.

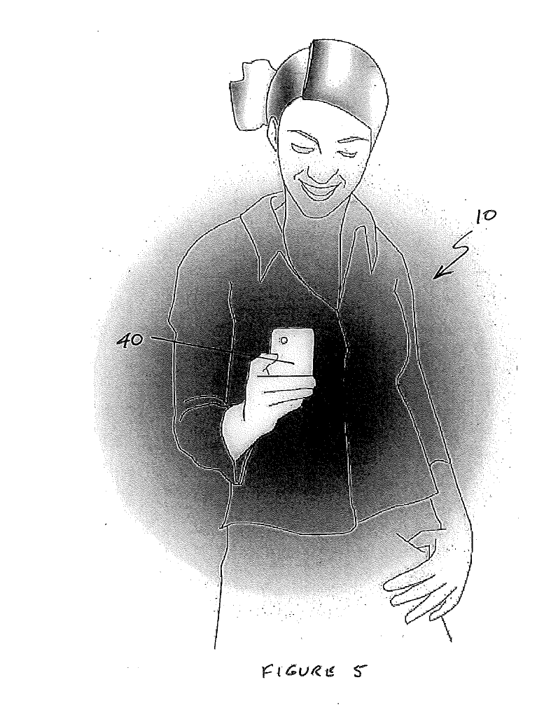

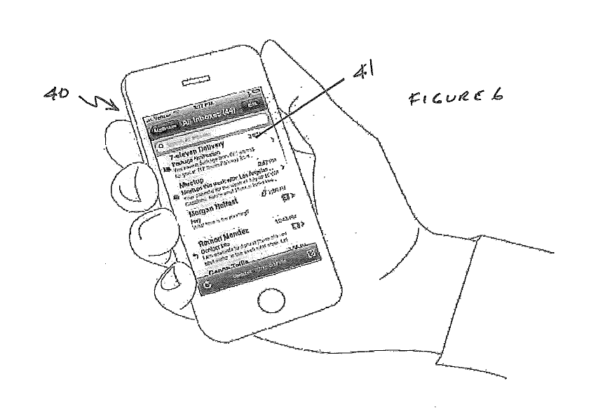

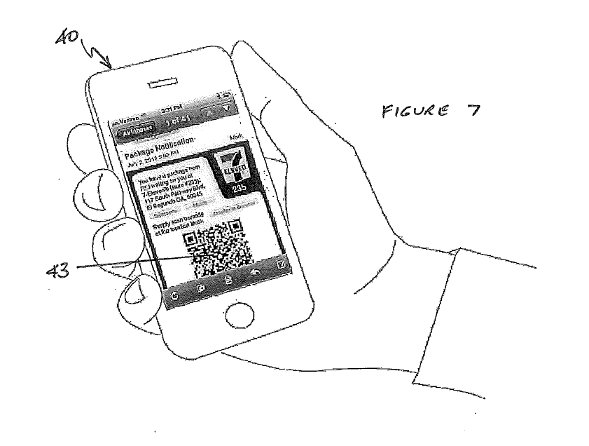

FIG. 5 shows recipient 10 receiving confirmation of delivery on her mobile phone 40. In this embodiment, confirmation of delivery is sent by email 41 as shown in FIG. 6. Embedded in email 41 or attached to it is QR code 43, shown in FIG. 7.

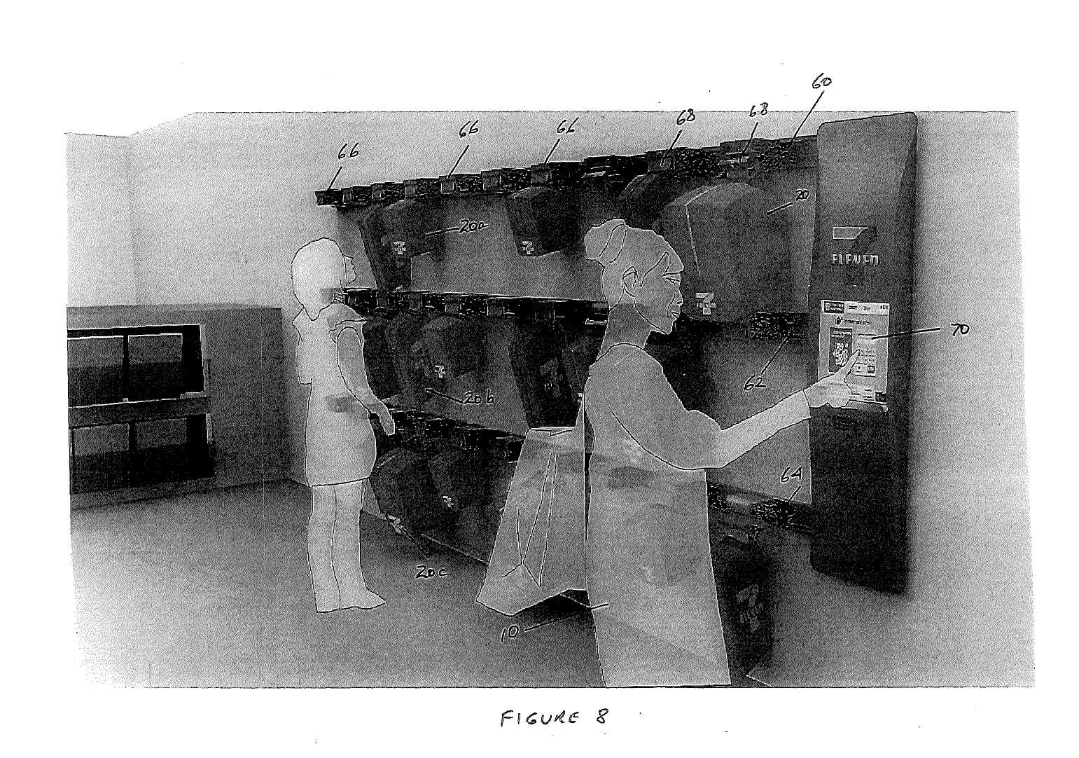

Turning now to FIG. 8, the delivery system of the invention in this embodiment has three rails 60, 62 and 64. Each rail 60, 62 and 64 has an extension 66, only some of which are labeled. In this embodiment, extensions 66 are equally distributed along rails 60, 62 and 64, but as earlier mentioned the invention is not limited to this.

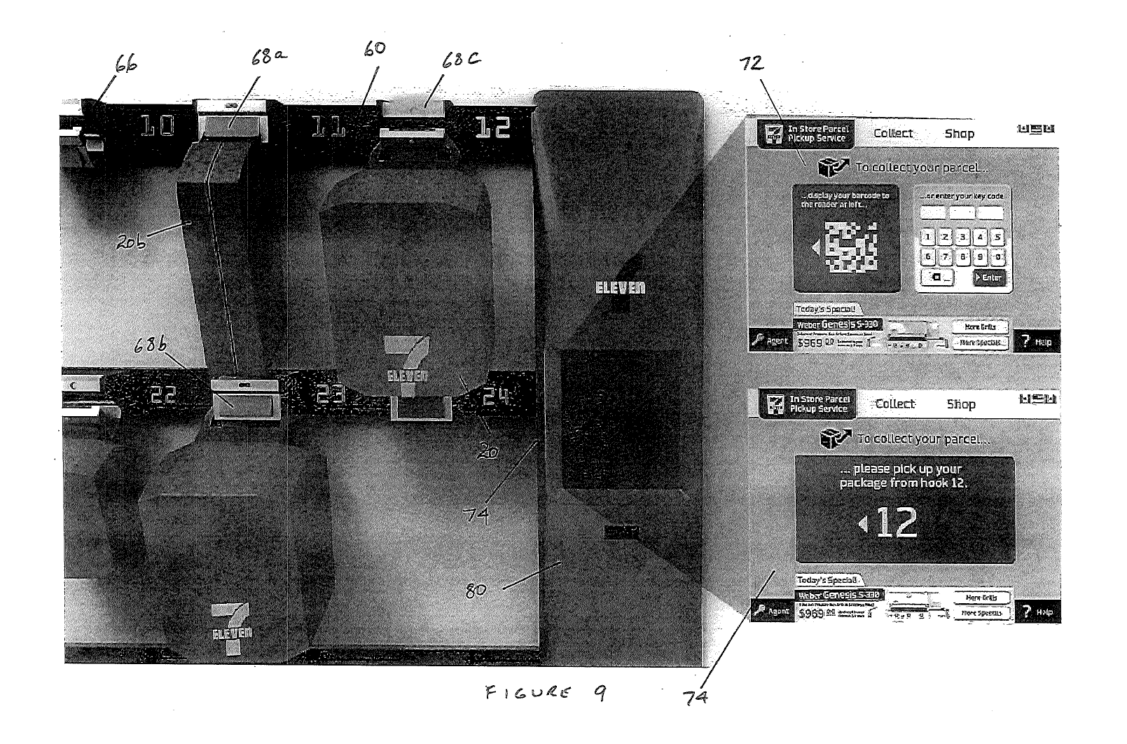

Each extension 66 has a fastener 68 which in this embodiment is in the form of a ‘beam’ fastener as described in, for example, International Patent Specification WO/2004/001235. Fastener 68 can be ‘pushed to lock’. FIG. 9 shows fasteners 68a and 69b in the locked position and fastener 68c after having been unlocked to release container 20 upon receipt of a signal.

FIG. 8 shows a range of containers, 20a, 20b and 20c, designed to accommodate small, medium and large items 24. Each container is locked to rail 60, 62 or 64 by fastener 68, except for container 20 which has been released after input of the appropriate code.

In FIG. 8, recipient 10 is shown entering a key code into keypad 70. This would be the procedure if recipient 10 had been given a key code, as opposed to a QR code, in email 41.

FIG. 9 shows in screen 72 two options presented to recipient 10—one to enter a key code, the other to display a barcode or QR code to a reader 74, located at the left of screen 72.

After entry of the appropriate key code at keypad 70 or reading of QR code 43 by reader 74, a processor in unit 80 sends a signal to fastener 68c locking container 20 to rail 60, releasing container 20 as shown in FIG. 9. At the same time, screen 74 displays information to recipient 10, advising the hook number (fastener 68c) from which container 10 has been released.

FIG. 10 shows container 20 in the form of a bag having a compartment 22 for accepting item 24. Container 10 has a closure 26 for compartment 22 in the form of a sliding clasp fastener with a pull 27.

In this embodiment, handle 28 is in two parts, 28a and 28b, which can be mated to form a closed loop 29 (FIGS. 11 and 12). When mated, handle 28 has a skirt 31 which covers pull 27 and therefore locks closure 26.

It is to be understood that the description of the preferred embodiment is not intended to be limiting on the scope of the invention and that the invention includes within its scope those adaptations and modifications which are within the spirit and concept of the invention.

### INDUSTRIAL APPLICABILITY

The invention is particularly suitable for use in a convenience store, supermarket or gas station, although the scope of the invention is not limited to these.

1. A secure storage device for a container, the device including:
a rail;
fastening means adapted to attach the container to the rail, the fastening means including a first locking means, wherein
the first locking means is adapted to release the container upon receipt of a signal.

2. The device of claim 1, wherein the fastening means is integral with the rail.

3. The device of claim 1, wherein the fastening means is slidable along the rail.

4. The device of claim 1, wherein the signal is a wireless signal.

5. The device of claim 1, wherein the fastening means includes a plurality of fasteners spaced apart along the rail.

6. A container for securely storing an item, the container including:
a compartment for receiving the item;
a closure for closing the compartment; and
a second locking means for locking the closure.

7. The container of claim 6, wherein the second locking means includes a loop attachment attached to the container.

8. The container of claim 7, wherein the loop attachment includes a first part and a second part and wherein the parts are releasably connected.

9. The container of claim 7, wherein the loop attachment forms a handle for the container.

10. The container of claim 8, wherein the first and second parts of the loop attachment form a skirt adapted to cover a portion of the closure.

11. The container of claim 6 further including a security tag to ensure that it is not removed without authorisation.

12. A delivery system for a container including:
the secure storage device of claim 1; and
means to send the signal to the first locking means.

13. The delivery system of claim 12 wherein the container is the container of claim 6.

14. A method of securely delivering an item including the steps of:
providing the secure storage device of claim 1;
placing the item in a container;
locking the container to the secure storage device with the first locking means; and
providing a recipient with means to generate the signal for releasing the container.

15. The method of claim 14 wherein the container is the container of claim 6, and including the step of locking the closure with the second locking means.

16. The method of claim 15, wherein the first and second locking means are combined.

17. The method of claim 14, further including the step of scanning a barcode on the item to electronically store delivery advice.
